(19) United States
(12) Patent Application Publication
(10) Pub. No.: US 2025/0014606 A1
(43) Pub. Date: Jan. 9, 2025

(54) CHAT APPLICATION FOR VIDEO CONTENT CREATION

(71) Applicant: Lemon Inc., Grand Cayman (KY)

(72) Inventors: Kin Chung Wong, Los Angeles, CA (US); Fan Chen, Los Angeles, CA (US); Xiu Pei, Beijing (CN); Yujie Li, Beijing (CN); Cheng Li, Beijing (CN); Chenman Zhou, Beijing (CN); Siqi Tan, Beijing (CN); Longyin Wen, Los Angeles, CA (US); Xiaohui Shen, Los Angeles, CA (US)

(21) Appl. No.: 18/346,695

(22) Filed: Jul. 3, 2023

(51) Int. Cl. G11B 27/031; G06F 40/20

(52) U.S. Cl. CPC G11B 27/031; G06F 40/20

(57) ABSTRACT

A computing system for video content creation executes a chat application to cause the processor to, in a chat conversation with a user in real-time, receive communication including a command from the user for interacting with a video content, use the large language model to analyze the command and generate a natural language response and a recommended action to implement on the video content based at least on the analyzed command, and implement the recommended action on the video content based at least on the analyzed command.

### BACKGROUND

The conventional art of video editing on social media platforms typically involves a user interface (UI) that presents numerous sections, menus, buttons, and tools. These features provide the ability to manipulate video content in various ways such as trimming clips, adjusting playback speed, adding transitions or special effects, overlaying text, and so forth. These user interfaces can provide a comprehensive set of tools that enable users to generate a broad range of creative video content.

However, a significant downside is that many of these features remain undiscovered or underutilized by the average user. Often, users do not fully explore the available video editing capabilities due to the complex nature of the UI, a lack of understanding about the functions of specific tools, or the perceived difficulty of the editing process. As a result, many users may not take full advantage of the platform's capabilities, and their video content may not achieve the desired effect or impact.

In addition, existing social media applications often fall short in providing personalized guidance for video editing. Specifically, they typically do not take into account the context of the video content when engaging users in conversation or providing recommendations. Users may not receive the most relevant assistance for their specific content, making the video editing process less intuitive and efficient.

### SUMMARY

Examples are provided relating to a chat application for video content creation. One aspect includes a computing system for video content creation, the computing system comprising a processor and memory storing a large language model and a chat application that, in response to execution by the processor, cause the processor to, in a chat conversation with a user in real-time, receive communication including a command from the user for interacting with a video content, use the large language model to analyze the command and generate a natural language response and a recommended action to implement on the video content based at least on the analyzed command, and implement the recommended action on the video content based at least on the analyzed command.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a computing system according to an example of the present disclosure.

FIGS. 2 to 13 illustrate examples of interactions between the user and the chat application of FIG. 1.

FIG. 14 is a flowchart of a method according to an example of the present disclosure.

FIG. 15 shows an example computing environment of the present disclosure.

### DETAILED DESCRIPTION

In view of the above issues, the present disclosure describes a computing system 10 which includes a computing device 12 having at least one processor 14, a memory 16, and a storage device 18. In this example implementation, the computing system 10 takes the form of a single computing device 12 storing a large language model 26 in the storage device 18. During run-time, the memory 16 stores the large language model 26 and a chat application 20 that is executable by the at least one processor 14 to perform various functions using the large language model 26, including generating recommended actions 40 and natural language responses 42 in a chat conversation with a user. The chat application 20 causes the processor 14 to, in a chat conversation with the user in real-time, receive communication 38 from the user, including a command 38a for interacting with a video content 32, use the large language model 26 to analyze the command 38a and generate at least a natural language response 42 and at least a recommended action 40 to implement on the video content 32 based at least on the analyzed command 38a, and implement the recommended action 40 on the video content 32 based at least on the analyzed command 38a. By performing these functions in real-time, a seamless interaction between the user and the chat application 20 can be provided.

In the context of the present disclosure, the chat application 20 may be embodied as an online application service of an online social media platform or a ‘chat bot’, which refers to an automated software tool designed and programmed to interact with users of a social media application through text-based or voice-based conversations. The chat application 20 may implement privacy features to obtain user consent to send user communication 38 to the large language model 26.

The chat application 20 causes a user interface 24 for the large language model 26 to be presented. The user interface 24 receives communication 38 from the user in the form of a command 38a and/or a message 38b for interacting with a video content 32, which may be uploaded by the user via the user interface 24. In some instances, the user interface 24 may be a portion of a graphical user interface (GUI) 22 for accepting user input and presenting information to a user. In other instances, the user interface 24 may be presented in non-visual formats such as an audio interface for receiving and/or outputting audio, such as may be used with a digital assistant. In yet another example the user interface 24 may be implemented as a prompt interface application programming interface (API). In such a configuration, the input to the user interface 24 may be made by an API call from a calling software program to the prompt interface API, and output can be returned in an API response from the prompt interface API to the calling software program. The GUI 22 or the user interface 24 may alternatively be executed on a client computing device which is separate and different from the computing device 12, so that the client computing device establishes communication with the computing device 12 utilizing a network connection, for example.

The video content 32 uploaded by the user may be processed by a video asset analyzer 34 to generate video metadata 36. The video asset analyzer 34 may pre-process the video to extract individual frames, analyze the visual content and audio content of the video content 32, and generate the video metadata 36 which includes textual descriptions of the analyzed visual and audio content, recognized entities, timestamps for key events, and video captioning of the video content 32.

The large language model 26 receives the video metadata 36 and the communication 38 from the user as input. The chat application 20 uses the large language model 26, trained on a plurality of data types including text, video, audio, and image data, to analyze the communication 38 and the video metadata 36 to generate a contextually relevant natural language response 42 or generate a recommended action 40 to implement on the video content 32. The chat application 20 may also recommend actions 40 to the user based on factors beyond the received communication 38. Such factors may include the video content 32 being created, a profile information of the user, the geo-location of the user, and content creation goals of the user, for example.

For example, the chat application 20 may determine the geo-location of the user using GPS or IP address of the device of the user, and the information may be utilized in the generation of contextually and geographically relevant responses 42 and recommended actions 40.

The large language model 26 may be trained to engage in navigational conversations to guide the user to use a tool on the user interface 24 of a video editing application 50 to edit the video content 32, thereby giving users a quick way to navigate to different editing features embedded deep into various user interface screens, for example. Accordingly, users who may have a general awareness of the different editing capabilities, but have trouble finding them can be guided by the navigational conversations of the chat application 20.

The large language model 26 may also be trained to engage in editing-focused conversations to suggest to the user one or more proposed edits to the video content 32. Such proposed edits may be chained together in an efficient way that normally would require significant manual work by the users through conventional user interfaces. Accordingly, users who have some specific ideas on how the video content 32 can be improved, but do not know the right tools in the video editing application 50 to use to make the edits to the video content 32 can be guided by the editing-focused conversations of the chat application 20.

The large language model 26 may also be trained to engage in explorational conversations to suggest ideas for future video content, thereby helping users discover a unique content vision. For example, the large language model 26 may ask about the interests and passions of the user, and make suggestions for future video content that aligns with the user's interests and passions. In one scenario, responsive to receiving cooking video content 32 from the user and receiving a message 38b that the user likes to cook and would like to focus on street food, the large language model 26 may suggest that the user share the process of recreating street food dishes, share stories from when the user first tasted the original version of the street food, and rate the user's own cooking against the real experience. Accordingly, users who do not have a general sense of the type of content that they want to make can be guided by the explorational conversations of the chat application 20.

A prompt manager 28 and a language processor 30 may process the communication 38 from the user before the large language model 26 receives the communication 38 as input. The language processor 30 may perform a series of language processing steps to pre-process the communication 38 from the user. For example the communication 38 may be cleaned by removing unnecessary punctuation or irrelevant characters, tokenizing the communication 38, and applying language detection or translation. Following the pre-processing of the communication 38 by the language processor 30, the prompt manager 28 may interpret the communication 38. For example, the prompt manager 28 may identify the intent of the user, recognizing the command 38a as a command, and the message 38b as a message, and also recognize questions and keywords within the communication 38. The prompt manager 28 may also identify and maintain the context of the conversation by tracking the interaction history of the user to ensure the generation of relevant and coherent natural language responses 42 by the large language model 26. The interpretations of the prompt manager 28, including the intent of the user, identified command 38a, identified message 38b, recognized questions and keywords, and identified context, may subsequently be received by the large language model 26 as input. The generated output from the large language model 26, including the recommended actions 40 and the natural language responses 42, may be pre-processed by the language processor 30 before the recommended actions 40 are implemented and the natural language responses 42 are displayed to the user.

The chat application 20 may cause the video editing application 50 to implement the recommended actions 40 on the video content 32 based on the analyzed communication 38 or the recommended actions 40 and generate edited video content 52. The actions 40 recommended by the chat application 20 and implemented by the video editing application 50 include but are not limited to adding a title, trimming, adding effects, changing audio, adding text, or adjusting the color of the video content 32.

An action agent 44 is configured to translate the recommended actions 40 and natural language responses 42 from the large language model 26 into action inputs 46 and tool selections 48 that are readable by the video editing application 50, and as output responses 58 that are displayed on the user interface 24. The action agent 44 may determine which of the actions 40 recommended by the large language model 26 are appropriate to be converted into action inputs 46 and tool selections 48 to be received by the video editing application 50. The action agent 44 may also determine which of the natural language responses 42 outputted by the large language model 26 will be outputted as output responses 58 that are displayed on the user interface 24. The video editing application 50 makes edits to the video content 32, implementing the recommended actions 40 on the video content 32 by implementing the tool selection 48 and the action input 46 to generate the edited video content 52.

Upon implementing the recommended actions 40, the edited video content 52 may be posted on the video cloud 54, and the chat application 20 may subsequently display an action confirmation 56 of the implemented action 40 on the user interface 24. The video cloud 54 may evaluate whether the video content 32 is sufficiently edited or ready to be published. Responsive to determining that the video content 32 is sufficiently edited or ready to be published, the chat application 20 may guide the user to complete a content publishing step. The readiness of the edited video content 52 to be published may be evaluated based on predetermined criteria, which may include lighting quality, sound quality, the presence of abrupt transitions or cuts, video length, narrative flow, and text legibility, for example.

A performance analytics module of the video cloud service 54 may be configured to analyze the performance of the edited video content 52, and generate performance analytics data for the edited video content 52 published on the video cloud service 54. The performance of the edited video content 52 may be observed based on factors including but not limited to view counts, likes, shares, comments, audience retention, and user engagement. For examples, as users of a social media platform view, like, share, and comment on the edited video content 52, the video cloud service 54 may track and record these interactions. The video cloud service 54 may also record metrics such as audience retention and overall user engagement, which may be a combination of analytics data regarding likes, comments, shares, and views.

The performance analytics data may be compiled into a continuously updated large dataset to train a reward model 60, which may inform a model trainer 62 which makes fine-tunes or makes adjustments and updates to the weights and biases of the prompt manager 28 and the large language model 26 based on the reward model 60. Accordingly, the recommended actions 40 and natural language responses 42 of the large language model 26 may be updated based on the user's latest preferences and behavior patterns.

Accordingly, the chat application 20 is configured to receive and interpret communication 38 from a user, including commands 38a, messages 38b, and uploaded video content 32, respond in a human-like manner with natural language responses 42, and perform recommend actions 40 on the video content 32 within the chat application 20. The large language model 26 receives video metadata 36 of the uploaded video content 32 being edited by the user as input, and the communication 38 from the user as input, so that recommended actions 40 may also reflect the context of the uploaded video content 32, thereby further enhancing the relevance of the outputted recommended actions 40 and natural language responses 42 to the user's communication 38. Therefore, interactions between the user and the chat application 20 are facilitated, and the overall user experience is enhanced within the chat application 20. Furthermore, since performance analytics data from the edited video content 52 is used to continuously train the large language model 26, a powerful feedback loop may increase the performance of the large language model 26 over time.

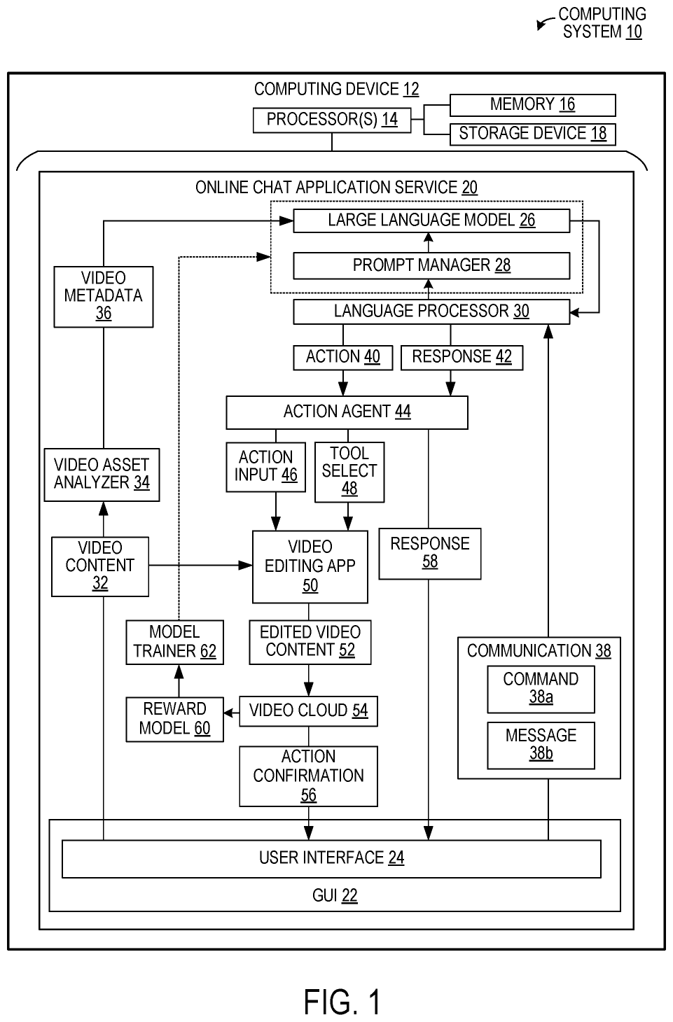

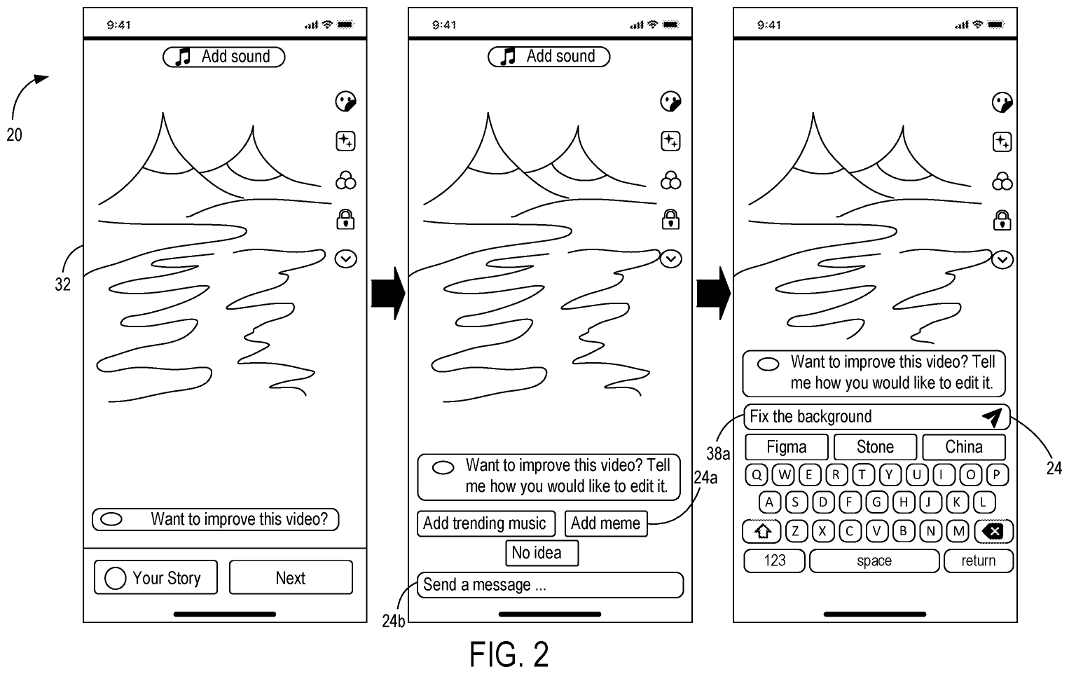

Turning to FIG. 2 with reference to the chat application 20 of FIG. 1, an example of the interactions between the user and the chat application 20 of FIG. 1 is shown. Here, the user posts video content 32 of a lake. The chat application prompts the user, “What to improve this video?” The user interacts with this prompt, and the chat application prompts the user further, “What to improve this video? Tell me how you would like me to edit it.” The chat application 20 then engages in an editing-focused conversation by presenting the user with three generated responses as buttons in a touch-based editing interface 24a: “Add a trending music”, “Add a meme”, “no idea”. If the user does not wish to select one of the three generated responses, the user may manually enter a command into the natural language interface 24b at the bottom of the screen. In this example, the user types “Fix the background” as a command 38a. In response, the large language model 26 may generate a recommended action 40 to fix the background by adjusting the colors of the background of the image, and this recommended action 40 may be implemented by the video editing application 50.

As demonstrated in the example of FIG. 2, users can discover, enter, and exit the user interface 24 quickly with minimal mental friction. User can interact with a natural language interface 24b and a traditional touch-based editing interface 24a at the same time. This achieves minimal disruption to the content creation flow of the user.

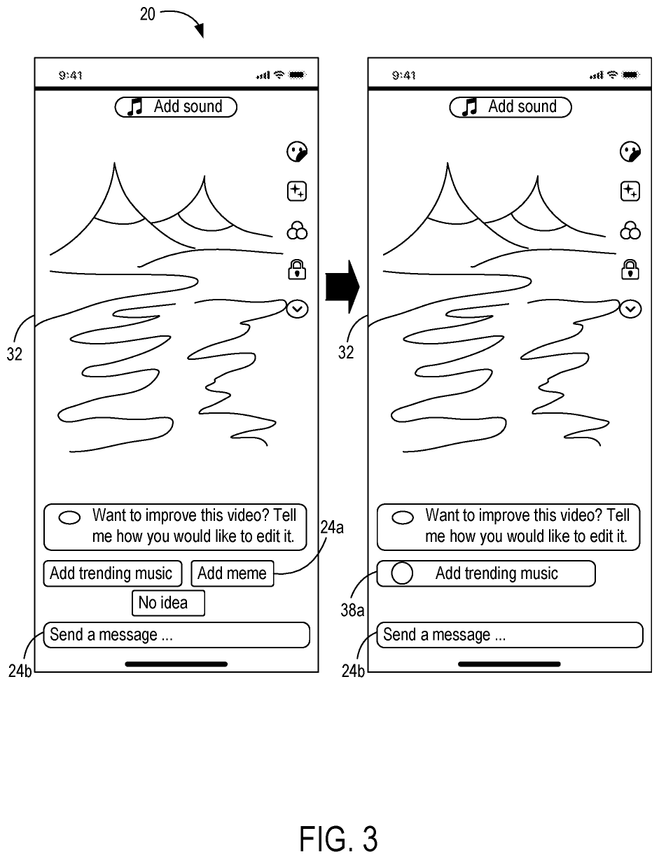

Referring to FIG. 3, the example of the interactions between the chat application 20 and the user of FIG. 2 continues. In response to the chat application 20 prompting the user, “What to improve this video? Tell me how you would like me to edit it”, the user may instead select the generated response, “Add a trending music” as the command 38a. As demonstrated in the example of FIG. 3, the communication 38 from the user can not only be typed text, but also a selection of a generated response in form of a button on a touch-based editing interface 24a. Users can be encouraged by the chat application 20 to interact with the chat application 20 and use natural language to actively suggest edits to the video content 32.

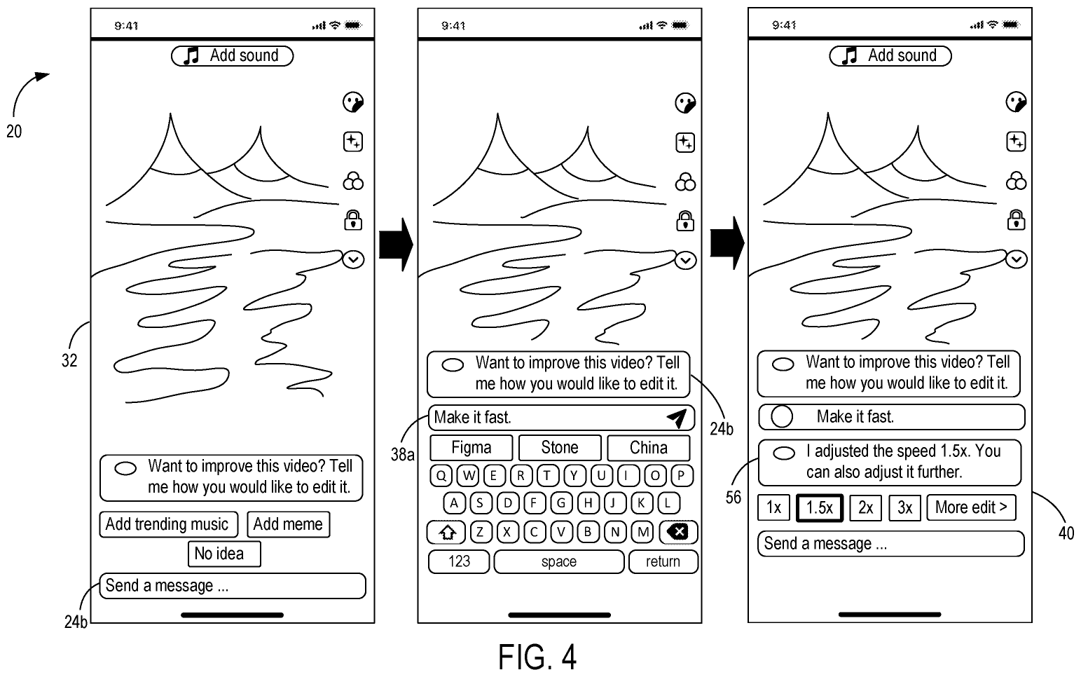

Referring to FIG. 4, the example of the interactions between the chat application 20 and the user of FIG. 2 continues, in which the chat application 20 engages in an editing-focused conversation with the user. In response to the chat application 20 prompting the user, “What to improve this video? Tell me how you would like me to edit it”, the user may choose to manually enter the command 38a, “Make it fast” into the natural language interface 24b at the bottom of the screen. In response, the large language model 26 may generate a recommended action 40 to adjust the speed of the video content 32, and this recommended action 40 is implemented by the video editing application 50. The chat application 20 then replies with an action confirmation 56, “I adjusted the speed 1.5×. You can also adjust it further”. The user is then presented with five generated responses as recommended actions 40 by the chat application 20: 1×, 1.5×, 2×, 3×, ‘more edits’. Accordingly, the user may modify the preselected speed of 1.5× to by issuing a command 38a to the chat application 20 to select 1×, 2×, or 3× instead, or select ‘more edits’ to manually enter a different speed.

As demonstrated in the example of FIG. 4, the chat application 20 may strategically know when to immediately apply a recommended action 40, present options directly to users within the chat, or present options indirectly to users via chat shortcuts or buttons.

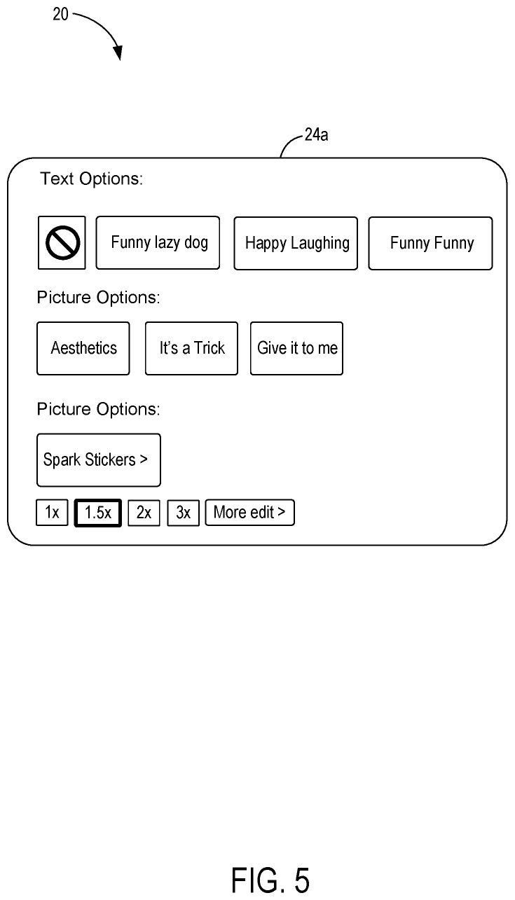

Referring to FIG. 5, the example of the interactions between the chat application and the user of FIG. 4 continues. In response to the chat application 20 prompting the user, “I adjusted the speed 1.5×. You can also adjust it further”, the user may select the generated response, ‘more edits’. Responsive to the user selecting the generated response ‘more edits’, the user is presented with a touch-based editing interface 24a from the video editing application 50, in which the user may select generated responses for three different options. The text options present the user with options to (1) opt out of adding text captions, (2) add ‘funny lazy dog’ themed text, (3) add ‘happy laughing’ themed text, or (4) ‘funny funny’ themed text. The picture options present users with three different picture templates. There is a ‘spark stickers’ feature button for the user to select to add stickers to the video content 32. The bottom bar presents the user with four different speed buttons: 1×, 1.5×, 2×, 3×, ‘more edit’ to select a video speed of the video content 32.

As demonstrated in the example of FIG. 5, the chat application 20 may decide when a recommended editing action 40 would more appropriately be performed in a full user interface mode. The users may be linked to main features when the chat interface is considered to be no longer appropriate.

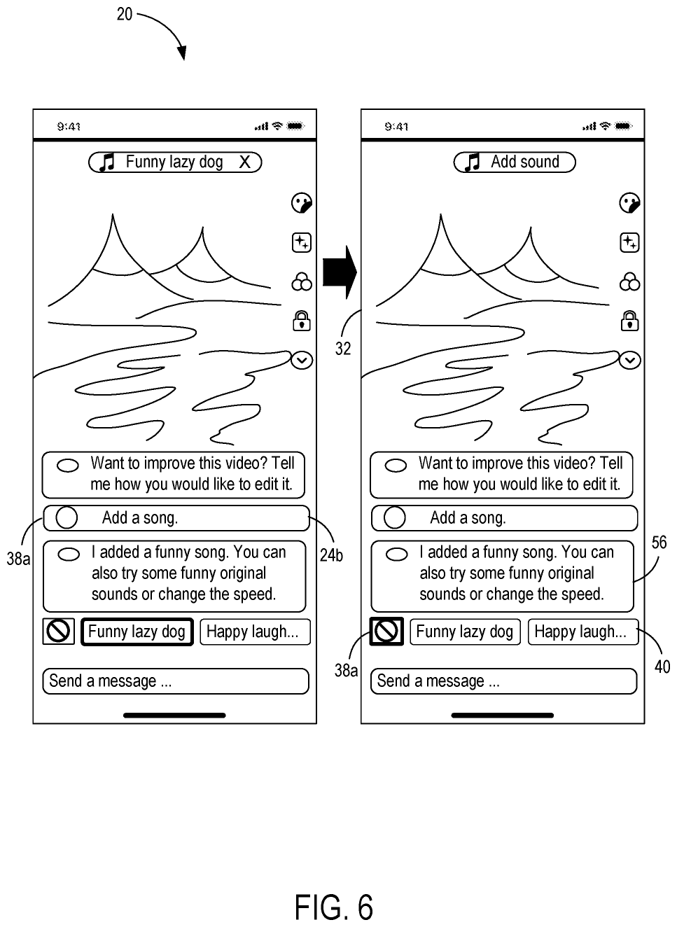

Referring to FIG. 6, the example of the editing-focused conversation between the chat application 20 and the user of FIG. 2 continues. In response to the chat application 20 prompting the user, “What to improve this video? Tell me how you would like me to edit it”, the user may choose to manually enter the command 38a, “Add a song” into the natural language interface 24b at the bottom of the screen. In response, the large language model 26 generates a recommended action 40, and causes the video editing application 50 to implement the recommended action 40 by adding a song to the video content 32. After completing the recommended action 40, the chat application 20 displays an action confirmation 56, “I added a funny song. You can also try some funny original sounds or change the speed”. The user is then presented with four generated responses: ‘cancel’, ‘funny lazy dog’, ‘happy laughing’, and ‘funny’ as recommended actions 40. In this example, the user issues a command 38a to select ‘cancel’ to opt out of adding a funny song, trying funny original sounds, or changing the speed of the video content 32.

As demonstrated in the example of FIG. 6, the chat application 20 may present users with the ability to undo recommended actions 40 that were implemented by the video editing application 50 when users change their minds, for example.

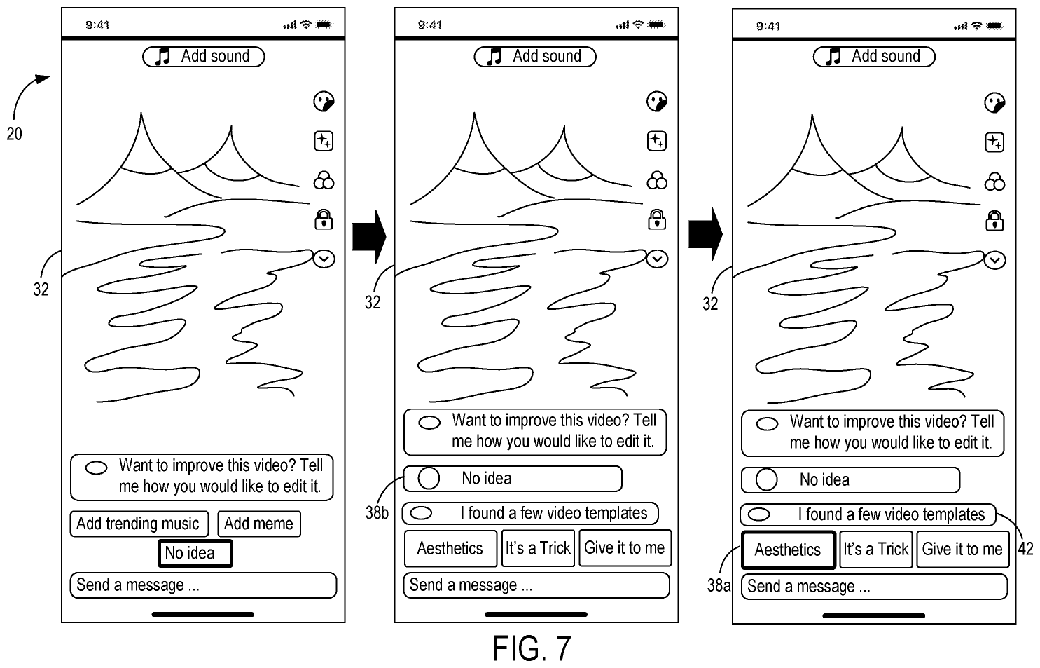

Referring to FIG. 7, the example of the interactions between the chat application 20 and the user of FIG. 2 continues. In response to the chat application 20 prompting the user, “What to improve this video? Tell me how you would like me to edit it”, the user selects, as a message 38b, the generated response, “No idea”. In response, the video asset analyzer 34 generates video metadata 36 of the posted video content 32. The large language model 26 receives the video metadata 36 as input, and generates recommended actions 40 and a natural language response 42. Then, the chat application 20 prompts the user with the natural language response 42, “I found a few templates for this video”, presenting the user with three different picture templates as the recommended actions 40. Here, the user selects the ‘aesthetics’ picture template as a command 38a.

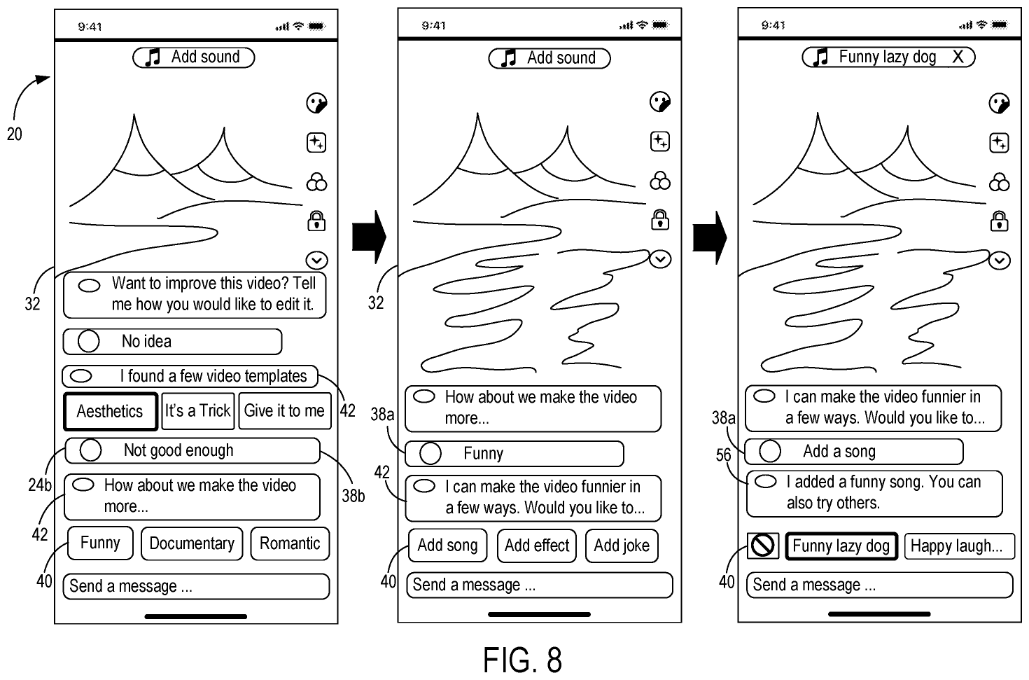

Referring to FIG. 8, the example of the interactions between the chat application 20 and the user of FIG. 7 continues. In response to the user selecting the ‘aesthetics’ picture template, the chat application 20 causes the video editing application 50 to implement the ‘aesthetics’ picture template on the video content 32. However, the user responds by typing a message 38b into the natural language interface 24b, ‘not good enough’, indicating that the user was not satisfied with the selected picture template. In response, the chat application 20 prompts the user with a natural language response 42, “How about we make the video more . . . ” and, as a recommended action 40, presents the user with three generated responses: ‘funny’, ‘documentary’, and ‘romantic’. Here, the user selects ‘funny’ as a command 38a. The chat application 20 then makes some suggestions by prompting with a natural language response 42, “I can make the video more funny in a few ways. Would you like to . . . ” and then, as a recommended action 40, presents the user with three generated responses: ‘Add a song’, ‘Add an effect’, and ‘Add a joke’. Here, the user selects ‘Add a song’ as a command 38a. In response, the chat application 20 adds a ‘funny lazy dog’ song to the video content 32. The chat application 20 then prompts the user with an action confirmation 56, “I added a funny song. You can also try others.” Then the chat application 20 presents, as recommended actions 40, the user with three generated responses: ‘cancel’, ‘funny lazy dog’, ‘happy laughing’, and ‘funny’. ‘funny lazy dog’ is already selected, but the user may opt to select a different generated response instead. For example, the user may opt to select ‘cancel’ to not add any song, or select the ‘happy laughing’ song or the ‘funny’ song instead.

As demonstrated in the examples of FIGS. 7 and 8, the ability of the chat application 20 to have explorational conversations with users can help users discover their own editing goals, whether it may be searching for music, finding effects, or general content goals.

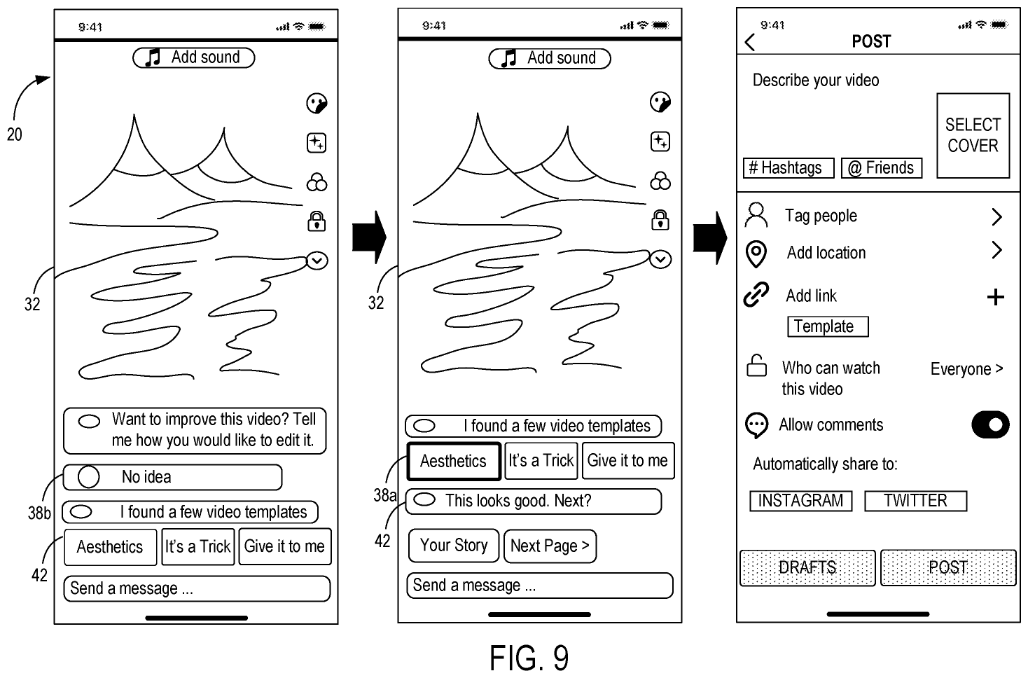

Referring to FIG. 9, the example of the editing-focused conversation between the chat application 20 and the user of FIG. 7 continues. In response to the chat application 20 prompting the user, “What to improve this video? Tell me how you would like me to edit it”, the user types, as a message 38b, “No idea”. In response, the video asset analyzer 34 generates video metadata 36 of the posted video content 32. The large language model 26 receives the video metadata 36 as input, and generates a recommended action 40 and a natural language response 42. The chat application 20 prompts the user with the natural language response 42, “I found a few templates for this video”. As the recommended action 40, the chat application 20 presents the user with three different picture templates to implement on the video content 32. Here, the user selects the ‘aesthetics’ picture template as a command 38a. In response, the chat application 20 causes the video editing application 50 to implement the ‘aesthetics’ picture template on the video content 32 as the recommended action 40.

Then, the chat application 20 evaluates whether the video content 32 is ready to be published using predetermined criteria regarding the lighting quality of the video content 32. Responsive to determining that the video content is ready to be published, the chat application 20 guides the user to complete a content publishing step by using a natural language response 42, “This looks good. Next?” and presents a ‘Next Page’ button, which is pressed by the user to show a video post interface which is configured to select permissions for the video content 32 to be posted. Before pressing the ‘post’ button to post the video, the user may type a video description into the ‘Describe your video’ box, tag people, add a location, add a link, manage permissions for others to view the video, allow comments, and automatically share the video content 32 on various social media platforms.

As demonstrated in the example of FIG. 9, the chat application 20 may help users decide when to commit to publish, thereby driving the creation funnel completion rate. The chat application 20 may know when enough editing is done and recommend users to post their videos, thereby driving video publication rates.

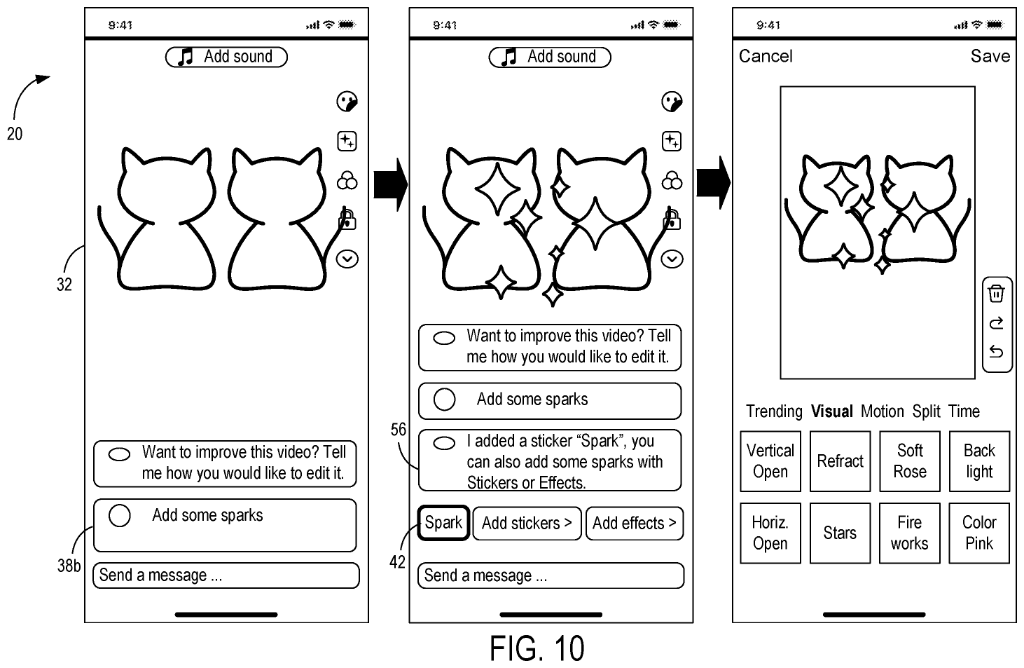

Referring to FIG. 10, another example of an editing-focused conversation between the chat application 20 and the user is shown. Here, the user posts a video content 32 of two cats. The chat application 20 prompts the user, “What to improve this video? Tell me how you would like me to edit it”. The user replies to this prompt by typing in the command 38a, “Add some sparks”. In response, the chat application 20 generates a recommended action 40, and causes the video editing application 50 to implement the recommended action 40 by applying sparks to the video content 32. Here, the chat application 20 notes that both stickers and effects can be recommended to the user to satisfy the goal of adding sparks to the video content 32. Therefore, the chat application 20 prompts the user further with an action confirmation 56 and an additional recommended action 40, “I added a sticker ‘Spark’, you can also add some sparks with Stickers or Effects.” The chat application 20 then presents the user with three generated responses as buttons: “Spark”, “Add stickers”, and “Add effects”. Upon pressing the “Add effects” button, the user is presented with a plurality of other available effects to apply to the video content 32, including ‘refraction’, ‘soft rose’, ‘backlight’, ‘stars’, and others.

As demonstrated in the example of FIG. 10, the chat application 20 may decide when an editing action is more appropriately performed in a full user interface, strategically linking users to main features when a chat interface is no longer sufficient. Further, the chat application 20 may generate multiple actions across multiple features from a single command 38a, so that multiple actions may be recommended to users when there is more than one way to achieve the goals of the user.

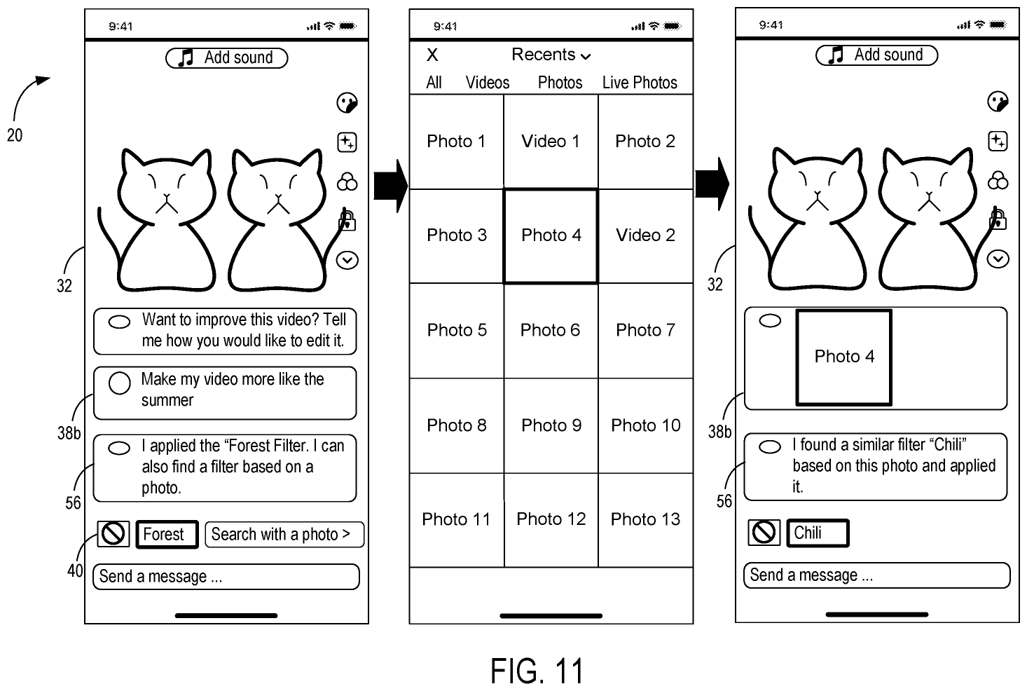

Referring to FIG. 11, another example of an editing-focused conversation between the chat application 20 and the user is shown. Here, the user posts a video content 32 of a flock of ducks. The chat application 20 prompts the user, “What to improve this video? Tell me how you would like me to edit it”. The user replies to this prompt by typing in a command 38a, “Make my video more like the summer”. In response, the chat application generates a recommended action 40, and causes the video editing application 50 to implement the recommended action 40 by applying the ‘Forest’ filter to the video content 32, and then prompts the user further with an action confirmation 56, “I added the Forest filter. I can also find a filter based on a photo”. The chat application 20 then presents the user with three generated responses as buttons: ‘Cancel’, ‘Forest’, and ‘Search with a photo’. Upon pressing the ‘Search with a photo’ button, the user is presented with a plurality of photos to select. The user selects a photo of a flock of ducks in water. In response, the chat application 20 analyzes the selected photo and selects the filter ‘Chili’ and applies it to the video content 32. The chat application 20 then replies to the user with an action confirmation 56, “I found a similar filter ‘Chili’ based on this photo and applied it to the video content 32.

As demonstrated in the example of FIG. 11, the chat application 20 may enable access to photo albums to perform actions that require visual content. A photo from a photo album may be used to search for a similar filter to apply to the video.

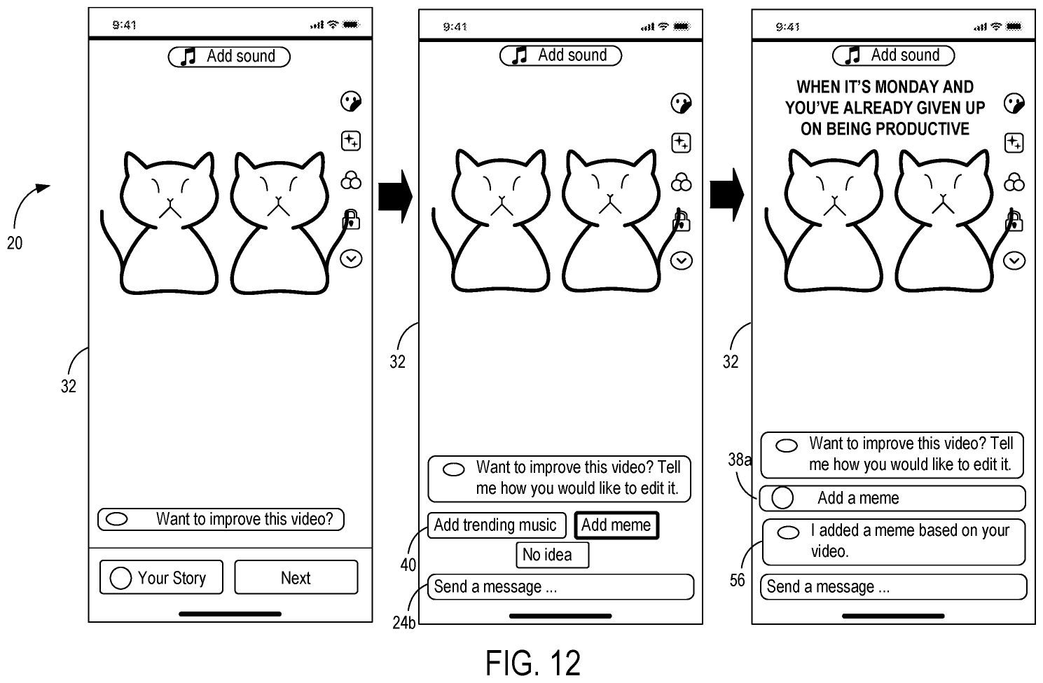

Referring to FIG. 12, another example of an editing-focused conversation between the chat application 20 and the user is shown. Here, the user posts a video content 32 of a cat. The video asset analyzer 34 generates video metadata 36 of the posted video content 32. The chat application 20 prompts the user, “Want to improve this video?” Upon the chat application 20 presenting the user with the ‘next button’, which the user presses, the chat application 20 further prompts the user, “What to improve this video? Tell me how you would like me to edit it”. The large language model 26 receives input of the video metadata 36 of the video content 32 and generates recommended actions 40, which are presented to the user as buttons: ‘Add a trending music’, ‘Add a meme’, and ‘No idea’. Responsive to the user pressing the ‘Add a meme’ button as a command 38a, the chat application 20 causes the video editing application 50 to add a meme to the video, and then prompts the user with an action confirmation 56, “I added a meme based on your video”.

As demonstrated in the example of FIG. 12, the chat application 20 may generate a recommended action 40 based on an understanding of what the video content 32 is. The chat application 20 may also generate immediate content, such as a meme and apply it to the video content 32. For example, the chat application 20 may write a joke or meme in a chat conversation and then, later on, apply the joke or meme as a video subtitle onto the video content 32.

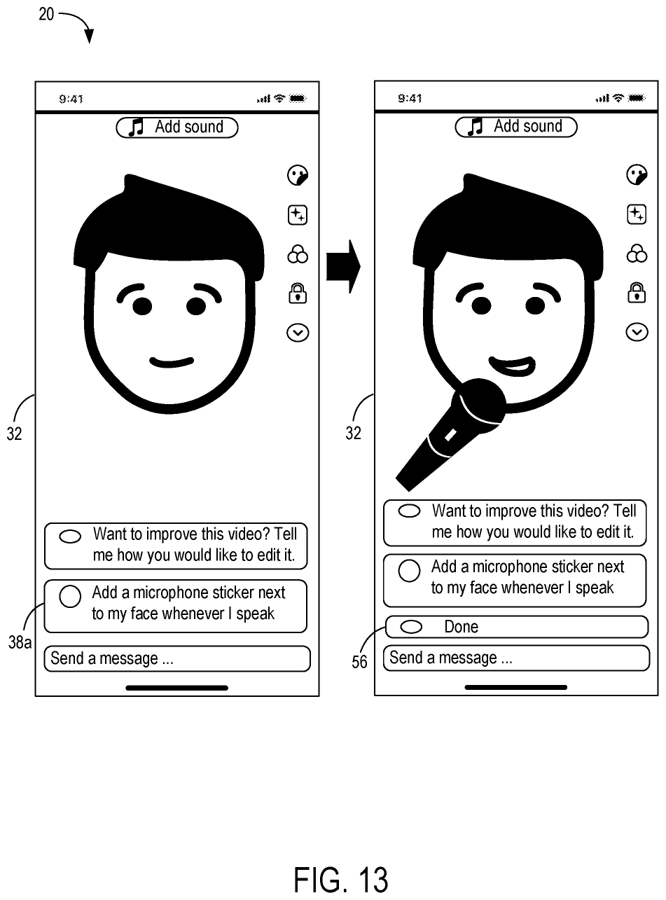

Referring to FIG. 13, another example of the interactions between the chat application and the user is shown. Here, the user posts video content 32 of a man. The chat application 20 prompts the user, “What to improve this video? Tell me how you would like me to edit it”. The user replies to this prompt by typing in the command 38a, “Add a microphone sticker next to my face whenever I speak”. In response, the large language model 26 generates a recommended action 40, and the chat application 20 causes the video editing application 50 to implement the recommended action 40 by applying the microphone sticker next to the face of the man in the video content 32, and then replies to the user with an action confirmation 56, “Done”.

As demonstrated in the example of FIG. 13, users who perform complex editing on video content 32 may save time. Using chat instructions, the users may instruct the chat application 20 to do broad-based editing that may be difficult to perform manually. Thus, complex editing can be performed by the chat application 20 using the natural language input from the user.

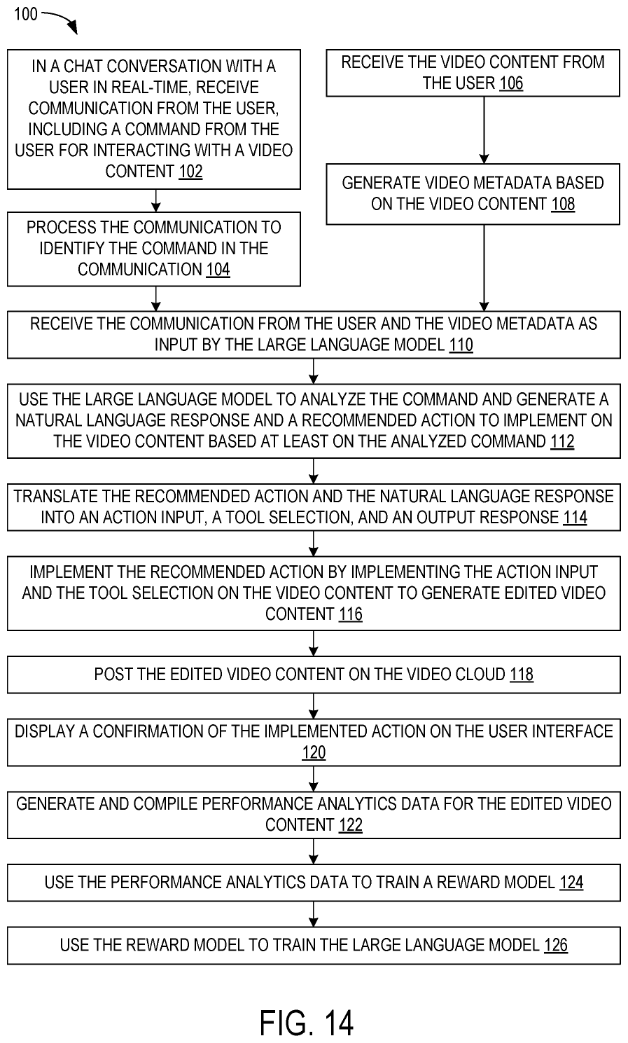

Turning to FIG. 14, a flowchart is illustrated of a method 100 for implementing actions on video content using a chat conversation. The following description of the method 100 is provided with reference to the software and hardware components described above and shown in FIG. 1. It will be appreciated that the method 100 also can be performed in other contexts using other suitable hardware and software components.

At step 102, in a chat conversation with a user in real-time, communication is received from the user, including a command from the user for interacting with a video content. At step 104, the communication is processed to identify the command in the communication. At step 106, the video content is received from the user.

At step 108, video metadata is generated based on the video content. At step 110, the communication from the user and the video metadata are received by the large language model as input. At step 112, a large language model is used to analyze the command and generate a natural language response and a recommended action to implement on the video content based at least on the analyzed command. At step 114, the recommended action and the natural language response are translated into an action input, a tool selection, and an output response. At step 116, the recommended action is implemented by the video editing application by implementing the action input and the tool selection to generate edited video content. At step 118, the edited video content is posted on the video cloud. At step 120, a confirmation of the implemented action is displayed on the user interface. At step 122, performance analytics data for the edited video content is generated and compiled. At step 124, the performance analytics data is used to train a reward model. At step 126, the reward model is used to train the large language model.

The above-described system and method are configured to enhance the user experience during the video editing process by deploying an advanced chat application 20 configured to receive, interpret, and respond to user inputs in a human-like manner in natural language chat conversations with the user. Such inputs may encompass natural language commands 38a, messages 38b, and uploaded video content 32, streamlining broad-based editing tasks that are typically challenging to perform manually. Consequently, the chat application 20 offers multi-faceted editing solutions, generating recommended actions 40 based on video content understanding, creating immediate content such as memes, and implementing recommended actions 40 in accordance with the user's intent as interpreted based on the user inputs. Moreover, the system and method may seamlessly integrate with photo albums, permitting visual content-based actions such as filter searches, all while promoting user exploration and creativity.

Furthermore, the chat application 20 may make strategic decisions regarding the transition to a full user interface when the editing actions surpass the capabilities of the chat interface. Additionally, the chat application 20 may assist users in deciding when the users are ready to publish their videos, thereby effectively boosting the video publication rate.

Notably, the chat application 20 encourages active interaction with users, offering the opportunity to provide their input through typed text or pre-generated responses. Accordingly, users can enter, navigate, and exit the chat interface 22 with minimal friction, supporting a seamless content creation flow.

By incorporating user communication 38 and video metadata 36 into the recommendation process, the chat application 20 ensures relevance in the output, significantly elevating the overall user experience within the chat application 20. The utilization of performance analytics data from the edited video content 52 as part of an ongoing learning process to train the large language model 26 fosters an iterative feedback loop that incrementally boosts the quality of the generated natural language responses 42 and recommended actions 40 over time.

In some embodiments, the methods and processes described herein may be tied to a computing system of one or more computing devices. In particular, such methods and processes may be implemented as a computer-application program or service, an application-programming interface (API), a library, and/or other computer-program product.

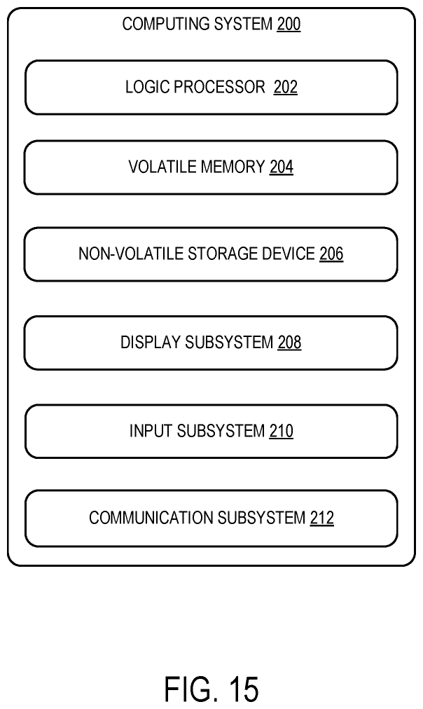

FIG. 15 schematically shows a non-limiting embodiment of a computing system 200 that can enact one or more of the methods and processes described above. Computing system 200 is shown in simplified form. Computing system 200 may embody an example computing environment in which the computing system 10 of FIG. 1 may be deployed. Computing system 200 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 200 includes a logic processor 202, volatile memory 204, and a non-volatile storage device 206. Computing system 200 may optionally include a display subsystem 208, input subsystem 210, communication subsystem 212, and/or other components not shown in FIG. 10.

Logic processor 202 includes one or more physical devices configured to execute instructions. For example, the logic processor 202 may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 202 may include one or more physical processors (hardware) configured to execute software instructions. Additionally or alternatively, the logic processor 202 may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor 202 optionally may be distributed among two or more separate devices, which may be remotely located and/or configured for coordinated processing. Aspects of the logic processor 202 may be virtualized and executed by remotely accessible, networked computing devices configured in a cloud-computing configuration. In such a case, these virtualized aspects are run on different physical logic processors of various different machines, it will be understood.

Non-volatile storage device 206 includes one or more physical devices configured to hold instructions executable by the logic processors to implement the methods and processes described herein. When such methods and processes are implemented, the state of non-volatile storage device 206 may be transformed—e.g., to hold different data.

Non-volatile storage device 206 may include physical devices that are removable and/or built-in. Non-volatile storage device 206 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, or game controller. In some embodiments, the input subsystem 210 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 200 to send and/or receive messages to and/or from other devices via a network such as the Internet.

The following paragraphs provide additional description of the subject matter of the present disclosure. One aspect provides a computing system for video content creation, comprising a processor, and a memory storing a large language model and a chat application that, in response to execution by the processor, cause the processor to in a chat conversation with a user, receive communication including a command from the user for interacting with video content, use the large language model to analyze the command and generate a natural language response and a recommended action to implement on the video content based at least on the analyzed command, and implement the recommended action on the video content based at least on the analyzed command. In this aspect, additionally or alternatively, the large language model may be trained to engage in navigational conversations to guide the user to use a tool on a user interface of a video editing application to edit the video content. In this aspect, additionally or alternatively, the large language model may be trained to engage in editing-focused conversations to suggest to the user one or more proposed edits to the video content. In this aspect, additionally or alternatively, the large language model may be trained to engage in explorational conversations to suggest ideas for future video content based on the video content. In this aspect, additionally or alternatively, the computing system may further comprise a prompt manager configured to process the communication from the user, identify the command from the user, and identify an intent of the user, wherein the identified command and identified intent are received as input by the large language model. In this aspect, additionally or alternatively, the large language model may generate the natural language response and the recommended action for the video content based on at least one selected from the group of the video content being created, profile information of the user, a geo-location of the user, and content creation goals of the user. In this aspect, additionally or alternatively, video metadata of the video content may be generated, and the video metadata may be received as input by the large language model. In this aspect, additionally or alternatively, the video metadata may comprise textual descriptions of visual and/or audio content of the video content. In this aspect, additionally or alternatively, the chat application may evaluate whether the video content is ready to be published, and responsive to determining that the video content is ready to be published, the chat application may guide the user to complete a content publishing step. In this aspect, additionally or alternatively, performance analytics data from the video content may be used to train the large language model.

Another aspect provides a method for video content creation, comprising in a chat conversation with a user, receiving communication including a command from the user for interacting with video content, using a large language model to analyze the command and generate a natural language response and a recommended action to implement on the video content based at least on the analyzed command, and implementing the recommended action on the video content based at least on the analyzed command. In this aspect, additionally or alternatively, the large language model may be trained to engage in navigational conversations to guide the user to use a tool on a user interface of a video editing application to edit the video content. In this aspect, additionally or alternatively, the large language model may be trained to engage in editing-focused conversations to suggest to the user one or more proposed edits to the video content. In this aspect, additionally or alternatively, the large language model may be trained to engage in explorational conversations to suggest ideas for future video content based on the video content. In this aspect, additionally or alternatively, the method may further comprise processing the communication from the user, identifying the command from the user, and identifying an intent of the user, wherein the identified command and identified intent are received as input by the large language model. In this aspect, additionally or alternatively, the large language model may generate the natural language response and the recommended action for the video content based on at least one selected from the group of the video content being created, a profile information of the user, a geo-location of the user, and content creation goals of the user. In this aspect, additionally or alternatively, video metadata of the video content may be generated, and the video metadata may be received as input by the large language model. In this aspect, additionally or alternatively, it may be evaluated whether the video content is ready to publish, and responsive to determining that the video content is ready to publish, the user may be guided to complete a content publishing step.

Another aspect provides a computing system comprising a processor and instructions stored in memory that when executed by the processor cause the processor to implement a chatbot for video content creation, the chatbot being configured to in a chat conversation with a user, receive communication including a command from the user for interacting with video content, use a large language model to analyze the command and generate a natural language response and a recommended action to implement on the video content based at least on the analyzed command, and implement the recommended action on the video content based at least on the analyzed command.

Another aspect provides a non-transitory computer readable medium for video content creation, the non-transitory computer readable medium comprising instructions that, when executed by a computing device, cause the computing device to implement the method of, in a chat conversation with a user, receiving communication including a command from the user for interacting with video content, using a large language model to analyze the command and generate a natural language response and a recommended action to implement on the video content based at least on the analyzed command, and implementing the recommended action on the video content based at least on the analyzed command.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for video content creation, comprising:
a processor; and
a memory storing a large language model and a chat application that, in response to execution by the processor, cause the processor to:
in a chat conversation with a user, receive communication including a command from the user for interacting with video content;
use the large language model to analyze the command and generate a natural language response and a recommended action to implement on the video content based at least on the analyzed command; and
implement the recommended action on the video content based at least on the analyzed command.

2. The computing system of claim 1, wherein the large language model is trained to engage in navigational conversations to guide the user to use a tool on a user interface of a video editing application to edit the video content.

3. The computing system of claim 1, wherein the large language model is trained to engage in editing-focused conversations to suggest to the user one or more proposed edits to the video content.

4. The computing system of claim 1, wherein the large language model is trained to engage in explorational conversations to suggest ideas for future video content based on the video content.

5. The computing system of claim 1, further comprising a prompt manager configured to:
process the communication from the user;
identify the command from the user; and
identify an intent of the user, wherein
the identified command and identified intent are received as input by the large language model.

6. The computing system of claim 1, wherein the large language model generates the natural language response and the recommended action for the video content based on at least one selected from the group of: the video content being created, profile information of the user, a geo-location of the user, and content creation goals of the user.

7. The computing system of claim 6, wherein
video metadata of the video content is generated; and
the video metadata is received as input by the large language model.

8. The computing system of claim 7, wherein the video metadata comprises textual descriptions of visual and/or audio content of the video content.

9. The computing system of claim 1, wherein
the chat application evaluates whether the video content is ready to be published; and
responsive to determining that the video content is ready to be published, the chat application guides the user to complete a content publishing step.

10. The computing system of claim 1, wherein performance analytics data from the video content is used to train the large language model.

11. A method for video content creation, comprising:
in a chat conversation with a user, receiving communication including a command from the user for interacting with video content;
using a large language model to analyze the command and generate a natural language response and a recommended action to implement on the video content based at least on the analyzed command; and
implementing the recommended action on the video content based at least on the analyzed command.

12. The method of claim 11, wherein the large language model is trained to engage in navigational conversations to guide the user to use a tool on a user interface of a video editing application to edit the video content.

13. The method of claim 11, wherein the large language model is trained to engage in editing-focused conversations to suggest to the user one or more proposed edits to the video content.

14. The method of claim 11, wherein the large language model is trained to engage in explorational conversations to suggest ideas for future video content based on the video content.

15. The method of claim 11, further comprising:
processing the communication from the user;
identifying the command from the user; and
identifying an intent of the user, wherein
the identified command and identified intent are received as input by the large language model.

16. The method of claim 11, wherein the large language model generates the natural language response and the recommended action for the video content based on at least one selected from the group of: the video content being created, a profile information of the user, a geo-location of the user, and content creation goals of the user.

17. The method of claim 16, wherein
video metadata of the video content is generated; and
the video metadata is received as input by the large language model.

18. The method of claim 11, wherein
it is evaluated whether the video content is ready to publish; and
responsive to determining that the video content is ready to publish, the user is guided to complete a content publishing step.

19. A computing system comprising:
a processor and instructions stored in memory that when executed by the processor cause the processor to implement a chatbot for video content creation, the chatbot being configured to:
in a chat conversation with a user, receive communication including a command from the user for interacting with video content;
use a large language model to analyze the command and generate a natural language response and a recommended action to implement on the video content based at least on the analyzed command; and
implement the recommended action on the video content based at least on the analyzed command.

20. A non-transitory computer readable medium for video content creation, the non-transitory computer readable medium comprising instructions that, when executed by a computing device, cause the computing device to implement the method of claim 11.
